(19) United States
(12) Patent Application Publication
(10) Pub. No.: US 2026/0005796 A1
(43) Pub. Date: Jan. 1, 2026

(54) CODEWORD RATE-MATCHING FOR SHARED CHANNEL DOWNLINK CONTROL INFORMATION TRANSMISSIONS

(71) Applicant: QUALCOMM Incorporated, San Diego, CA (US)

(72) Inventors: Morteza SOLTANI, San Diego, CA (US); Jing SUN, San Diego, CA (US); Jing JIANG, San Diego, CA (US)

(21) Appl. No.: 18/760,899

(22) Filed: Jul. 1, 2024

(51) Int. Cl. H04L 1/00

(52) U.S. Cl. CPC H04L 1/0068; H04L 1/0071

(57) ABSTRACT

Methods, systems, and devices for wireless communications are described. A network entity may output a first downlink control information (DCI) message via a downlink control channel that is broadcast to a plurality of user equipment (UEs). The network entity may output, in accordance with the first DCI message, a second DCI message via a downlink shared channel that is broadcast to the plurality of UEs, the second DCI message that may include UE-specific control information for each UE of the plurality of UEs and the UE-specific control information included in the second DCI message may include a plurality of codewords that are block interleaved in accordance with a rate matching rule. The network entity may communicate with at least one of the plurality of UEs in accordance with the second DCI message.

### FIELD OF TECHNOLOGY

The following relates to wireless communications, including codeword rate-matching for shared channel downlink control information transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a network entity is described. The method may include outputting a first downlink control information (DCI) message via a downlink control channel that is broadcast to a set of multiple user equipment (UEs), outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule, and communicating with at least one of the set of multiple UEs in accordance with the second DCI message.

A network entity for wireless communications is described. The network entity may include one or more memories storing processor executable code, and one or more processors coupled with the one or more memories. The one or more processors may individually or collectively be operable to execute the code to cause the network entity to output a first DCI message via a downlink control channel that is broadcast to a set of multiple UEs, output, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule, and communicate with at least one of the set of multiple UEs in accordance with the second DCI message.

Another network entity for wireless communications is described. The network entity may include means for outputting a first DCI message via a downlink control channel that is broadcast to a set of multiple UEs, means for outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule, and means for communicating with at least one of the set of multiple UEs in accordance with the second DCI message.

A non-transitory computer-readable medium storing code for wireless communications is described. The code may include instructions executable by one or more processors to output a first DCI message via a downlink control channel that is broadcast to a set of multiple UEs, output, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule, and communicate with at least one of the set of multiple UEs in accordance with the second DCI message.

Some examples of the method, network entities, and non-transitory computer-readable medium described herein may further include operations, features, means, or instructions for encoding a set of information bits corresponding to the UE-specific control information for each UE to generate the set of multiple codewords, writing respective sets of coded bits to at least one row of a set of multiple rows of a block interleaver in accordance with the rate matching rule, each respective set of coded bits corresponding to a codeword of the set of multiple codewords, reading, from the block interleaver, the coded bits corresponding to the set of multiple codewords, where the coded bits may be sequentially read from a set of multiple columns of the block interleaver, and mapping the coded bits to a set of resources associated with the downlink shared channel based on reading the coded bits from the block interleaver, where the second DCI message may be output via the downlink shared channel based on mapping the coded bits to the set of resources.

In some examples of the method, network entities, and non-transitory computer-readable medium described herein, the rate matching rule may be associated with uniform block-interleaved rate matching of a same quantity of encoded bits for each codeword, where a quantity of the set of multiple rows may be equal to a quantity of the set of multiple codewords, and where a quantity of the set of multiple columns may be equal to a quantity of coded bits in each set of coded bits.

In some examples of the method, network entities, and non-transitory computer-readable medium described herein, the rate matching rule may be associated with rate matching different quantities of encoded bits for each codeword, and where a quantity of the set of multiple rows may be based on a quantity of the set of multiple codewords.

In some examples of the method, network entities, and non-transitory computer-readable medium described herein, a quantity of the set of multiple columns may be equal to a smallest quantity of coded bits from the respective sets of coded bits, and where the quantity of the set of multiple rows may be based on the respective sets of coded bits and the smallest quantity of coded bits.

In some examples of the method, network entities, and non-transitory computer-readable medium described herein, a quantity of the set of multiple columns includes a preconfigured quantity and the method, apparatuses, and non-transitory computer-readable medium may include further operations, features, means, or instructions for determining that a total quantity of coded bits across the respective sets of coded bits may be less than the quantity of the set of multiple columns and repeating one or more coded bits from at least one of the respective sets of coded bits based on determining that the total quantity of coded bits may be less than the quantity of the set of multiple columns.

Some examples of the method, network entities, and non-transitory computer-readable medium described herein may further include operations, features, means, or instructions for repeating the one or more coded bits may be based on a threshold code rate associated with at least one codeword of the set of multiple codewords.

In some examples of the method, network entities, and non-transitory computer-readable medium described herein, a quantity of the set of multiple columns includes a preconfigured quantity and the method, apparatuses, and non-transitory computer-readable medium may include further operations, features, means, or instructions for determining that a total quantity of coded bits across the respective sets of coded bits may be greater than the quantity of columns and puncturing one or more coded bits from at least one of the respective sets of coded bits based on determining that the total quantity of coded bits may be greater than the quantity of columns.

Some examples of the method, network entities, and non-transitory computer-readable medium described herein may further include operations, features, means, or instructions for puncturing the one or more coded bits may be based on a threshold code rate associated with at least one codeword of the set of multiple codewords.

Some examples of the method, network entities, and non-transitory computer-readable medium described herein may further include operations, features, means, or instructions for encoding a set of information bits corresponding to the UE-specific control information for each UE to generate the set of multiple codewords, mapping respective sets of coded bits to respective sets of resource elements, each respective set of coded bits corresponding to a codeword of the set of multiple codewords, writing the respective sets of resource elements to respective rows of a set of multiple rows of a block interleaver in accordance with the rate matching rule, reading, from the block interleaver, the resource elements corresponding to the respective sets of resource elements, where the resource elements may be sequentially read from a set of multiple columns of the block interleaver, and mapping the resource elements to a set of resources associated with the downlink shared channel based on reading the resource elements from the block interleaver, where the second DCI message may be output via the downlink shared channel based on mapping the resource elements to the set of resources.

In some examples of the method, network entities, and non-transitory computer-readable medium described herein, the rate matching rule may be associated with resource element-based block interleaving of a same quantity of encoded bits for each codeword, where a quantity of the set of multiple rows may be equal to a quantity of the set of multiple codewords, and where a quantity of the set of multiple columns may be equal to a quantity of coded bits in each set of coded bits divided by a quantity of coded bits associated with each resource element.

In some examples of the method, network entities, and non-transitory computer-readable medium described herein, the rate matching rule may be associated with rate matching for different quantities of encoded bits for each codeword, where each codeword may be associated with a different modulation order, and where a quantity of the respective rows may be based on a quantity of the set of multiple columns.

In some examples of the method, network entities, and non-transitory computer-readable medium described herein, the quantity of the set of multiple columns may be equal to a smallest quantity of resource elements from the respective sets of resource elements, and where the quantity of the set of multiple rows may be based on the respective sets of resource elements and the smallest quantity of coded bits.

In some examples of the method, network entities, and non-transitory computer-readable medium described herein, a quantity of the set of multiple columns includes a preconfigured quantity and the method, apparatuses, and non-transitory computer-readable medium may include further operations, features, means, or instructions for determining that a total quantity of resource elements across the respective sets of resource elements may be less than the quantity of the set of multiple columns and repeating one or more resource elements from at least one of the respective sets of resource elements based on determining that the total quantity of resource elements may be less than the quantity of the set of multiple columns.

Some examples of the method, network entities, and non-transitory computer-readable medium described herein may further include operations, features, means, or instructions for repeating the one or more resource elements may be based on a threshold code rate associated with at least one codeword of the set of multiple codewords.

In some examples of the method, network entities, and non-transitory computer-readable medium described herein, a quantity of the set of multiple columns includes a preconfigured quantity and the method, apparatuses, and non-transitory computer-readable medium may include further operations, features, means, or instructions for determining that a total quantity of resource elements across the respective sets of resource elements may be greater than the quantity of columns and puncturing one or more resource elements from at least one of the respective sets of resource elements based on determining that the total quantity of resource elements may be greater than the quantity of columns.

Some examples of the method, network entities, and non-transitory computer-readable medium described herein may further include operations, features, means, or instructions for puncturing the one or more resource elements may be based on a threshold code rate associated with at least one codeword of the set of multiple codewords.

In some examples of the method, network entities, and non-transitory computer-readable medium described herein, a quantity of the set of multiple codewords may be based on one or more parameters associated with the set of multiple UEs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports codeword rate-matching for shared channel downlink control information (DCI) transmissions in accordance with one or more examples as disclosed herein.

FIG. 2 shows an example of a wireless communications system that supports codeword rate-matching for shared channel DCI transmissions in accordance with one or more examples as disclosed herein.

FIG. 3 shows an example of a DCI scheme that supports codeword rate-matching for shared channel DCI transmissions in accordance with one or more examples as disclosed herein.

FIG. 4 shows an example of a DCI scheme that supports codeword rate-matching for shared channel DCI transmissions in accordance with one or more examples as disclosed herein.

FIG. 5 shows an example of a DCI scheme that supports codeword rate-matching for shared channel DCI transmissions in accordance with one or more examples as disclosed herein.

FIG. 6 shows an example of a DCI scheme that supports codeword rate-matching for shared channel DCI transmissions in accordance with one or more examples as disclosed herein.

FIG. 7 shows an example of a DCI scheme that supports codeword rate-matching for shared channel DCI transmissions in accordance with one or more examples as disclosed herein.

FIG. 8 shows an example of a DCI scheme that supports codeword rate-matching for shared channel DCI transmissions in accordance with one or more examples as disclosed herein.

FIGS. 9 and 10 show block diagrams of devices that support codeword rate-matching for shared channel DCI transmissions in accordance with one or more examples as disclosed herein.

FIG. 11 shows a block diagram of a communications manager that supports codeword rate-matching for shared channel DCI transmissions in accordance with one or more examples as disclosed herein.

FIG. 12 shows a diagram of a system including a device that supports codeword rate-matching for shared channel DCI transmissions in accordance with one or more examples as disclosed herein.

FIG. 13 shows a flowchart illustrating methods that support codeword rate-matching for shared channel DCI transmissions in accordance with one or more examples as disclosed herein.

### DETAILED DESCRIPTION

In wireless communications, downlink control information (DCI) may be transmitted over a control channel, and a user equipment (UE) receiving such DCI may engage in blind decoding of many decoding candidates to identify the DCI targeting the UE. To reduce such blind decoding, some techniques may include transmission of a first portion of DCI on a control channel (e.g., which is decoded blindly) and a second portion of DCI on a shared channel (which may only include the DCI, and which may be referred to as a DCI-only transmission) that may include an aggregated payload for multiple UEs encoded into multiple codewords. However, some techniques may not include procedures or rules for rate matching and interleaving of such multiple codewords.

The subject matter described herein may involve the use of a block interleaver to mix coded bits from all codewords to achieve maximum diversity and fair resource selection for each codeword. For example, in some cases, some or all of the codewords may be associated with a common modulation and coding scheme (MCS) (e.g., the entire second portion of the DCI may be carried with one modulation order and one coding rate. Additionally, or alternatively, the codewords may be mapped to different modulation orders and coding rates (e.g., different UEs may be grouped together and have their corresponding DCI components encoded with different MCS parameters). In either case, rate-matching and interleaving may be employed according to one or more rules or procedures. For example, the rate-matching and interleaving may be performed for codewords that all have the same quantity of coded bits, in which the codewords may be written in rows of an interleaving table (e.g., a buffer) and the interleaving process may read the columns of the interleaving table. In some examples, a first dimension of the interleaving table (e.g., a quantity of columns) may be a fixed value or may correspond with the shortest length codeword of the codewords to be transmitted. In some examples, if a codeword is too short (e.g., the length of the codeword is less than the fixed value), one or more repetitions of portions of the codeword may be included for the interleaving. Additionally, or alternatively, if a codeword is too long (e.g., the length of the codework is greater than the fixed value or is longer than the smallest codeword length), the codeword may be punctured (e.g., one or more portions of the codeword may be excluded from the interleaving process). In some examples, the rate-matching or interleaving may be performed on a bit-level basis or a resource element (RE) basis, where multiple bits are mapped to each resource element. In at least these ways, communications quality, throughout, resource utilization, flexibility, communications diversity, and reliability may be increased while reducing overhead and latency.

Aspects of the disclosure are initially described in the context of wireless communications systems. Aspects of the disclosure are then described with reference to a wireless communications system and DCI schemes. Aspects of the disclosure are further illustrated by and described with reference to apparatus diagrams, system diagrams, and flowcharts that relate to codeword rate-matching for shared channel DCI transmissions.

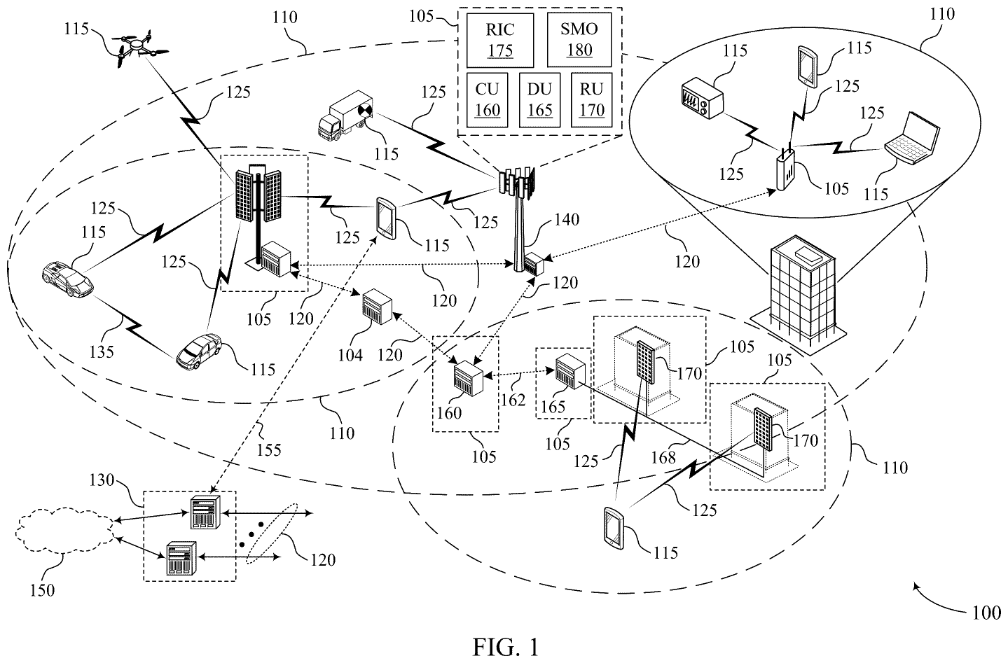

FIG. 1 shows an example of a wireless communications system 100 that supports codeword rate-matching for shared channel DCI transmissions in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (cMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a relatively highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a relatively highest signal strength, relatively highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

For example, a network entity 105 may transmit a first portion of DCI over a control channel (e.g., a PDCCH) to one or more UEs 115. The network entity 105 may further transmit a second portion of DCI over a shared channel (e.g., a PDSCH) to the one or more UEs 115. The UEs 115 may decode the first portion of the DCI transmitted over the control channel and may further receive the second portion of the DCI based on the decoding of the first portion of the DCI. The second portion of the DCI may include UE-specific control information for some or all of the UEs 115 that receive the first portion of the DCI and the second portion of the DCI. The UE-specific control information included in the second DCI may include codewords whose information are block interleaved (e.g., at the bit level or at the RE level, where portions of the information are mapped to REs and the information is interleaved in blocks according to the mapping to the REs) and rate-matched.

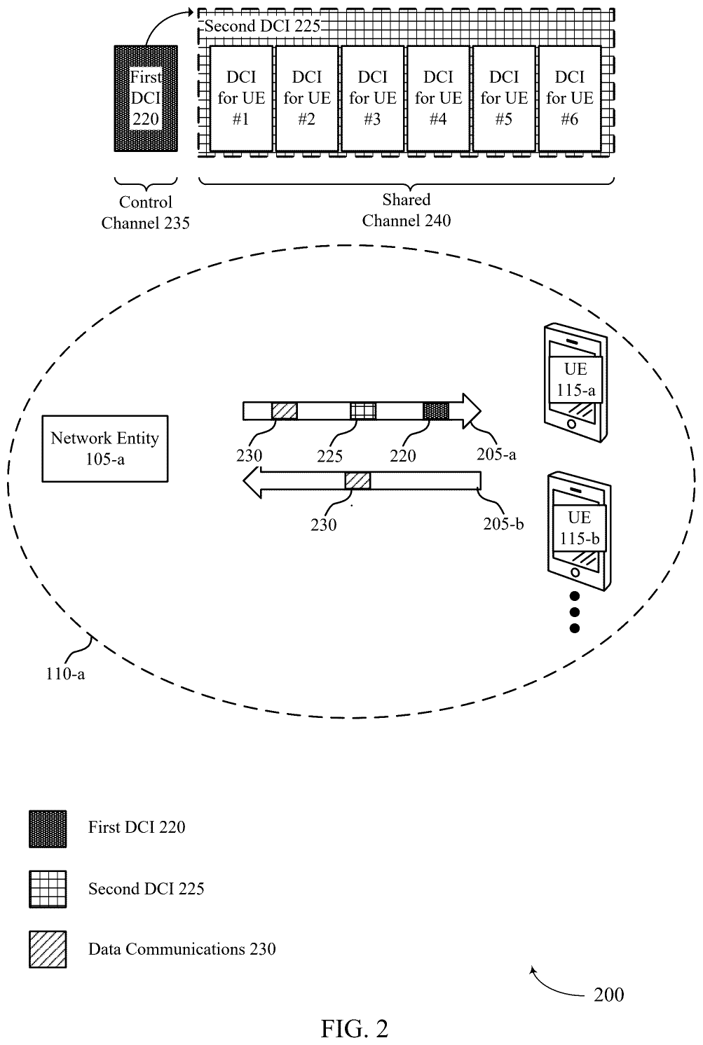

FIG. 2 shows an example of a wireless communications system 200 that supports codeword rate-matching for shared channel DCI transmissions in accordance with one or more examples as disclosed herein. The wireless communications system 200 may include the network entity 105-a, which may be an example of one or more network entities discussed in relation to other figures. The wireless communications system 200 may include the UE 115-a, the UE 115-b, and one or more other UEs, which may be examples of UEs discussed in relation to other figures. In some examples, the UE 115-a, the UE 115-b, and one or more other UEs 115 may be located in a geographic coverage area 110-a that may be associated with the network entity 105-a. The network entity 105-a, the UE 115-a, the UE 115-b, and the one or more other UEs 115 may communicate with each other (e.g., via one or more downlink communication links 205-a and one or more uplink communication links 205-b one or more sidelinks, or any combination thereof).

In wireless communications, DCI is used for multiple purposes (e.g., downlink grant, uplink grant, or other control signaling). In some examples, DCI is transferred via a control channel such as a physical downlink control channel (PDCCH) or other control channel which is delivered in a core resource set (CORESET). The UE 115-a receiving such a DCI may perform blind decoding (BD) of multiple decoding candidates in the CORESET to identify the DCI targeting the UE 115-a. In some examples, the blind decoding candidates are organized into search space sets and one or more search space sets may be associated with a CORESET.

In some examples, PDCCH BD design may be based on a case in which there are many UEs 115 to be served with PDCCH at the same time. This may involve reduced blocking between UEs 115 to randomly hash locations of PDCCH from different UEs 115 differently in the coreset. Generally speaking, BD results in a non-negligible processing burden and thus higher complexity for the UE 115-a.

In some examples, DCI piggybacking may be employed. Piggybacking may involve offloading control signaling from the PDCCH region, thereby effectively reducing the amount of BD employed in operation. In such cases, the size of DCI in PDCCH signaling may be reduced, saving PDCCH resources for other UEs 115, such as those that have not received a downlink (DL) grant. This also results in increased efficiency for the control delivery, as there is less cyclic redundancy check (CRC) overhead involved in aggregating multiple DCIs, CRC length may be reduced, fewer or less-involved pruning operations may be employed, control signaling demodulation reference signal (DMRS) and data DMRS may be shared, beamforming may be improved, and rank efficiency may be improved. In some examples, a system may reuse data rate control for control, possibly with a backoff for higher reliability compared to data transmissions, due to a lack of retransmission for control signaling. Additionally, or alternatively, such approaches may offload a variable length portion of DCI (e.g., DCI1) to a second portion of DCI (e.g., DCI2), which may be piggybacked on physical downlink shared channel (PDSCH) or other shared channel signaling, which may allow easier alignment of the size for DCI1 (e.g., carried over PDCCH) across multiple formats. Further, less blind decoding may be employed, reducing both the processing burden and complexity of operations at the UE 115-a.

In some examples, in a unicast mode, the UE 115-a specific control information may be transferred to the UE 115-a. After the UE 115-a blindly decodes a unicast DCI1 over a PDCCH using its cell radio network temporary identifier (C-RNTI), the UE 115-a ID field may not be included in DCI2 signaling carried over PDSCH. For example, a DCI1 transmitted on a PDCCH that is associated with a search space set or a CORESET may be blind decoded by the UE 115-a.

In a broadcast/multicast mode, a network entity 105-a may address some or all associated UEs 115 in a DCI1 transmitted over a PDCCH and may further includes all the corresponding the UE 115-a-specific control information for each the UE 115 in a DCI2 transmission carried over PDSCH. For example, the network entity 105-a may be tasked with transmitting multiple grants to multiple UEs 115 (e.g., DL grants or uplink (UL) grants) where each the UE 115-a may be configured with a DL grant or an UL grant. In such a case, the network entity 105-a may transmit the DCI1 over PDCCH to one or more UEs 115 and may further transmit over a PDSCH to transfer each the UE's 115 specific DCI (e.g., in a DCI2 transmission). In such a case, it is desirable that this PDSCH transmission (e.g., the DCI2 transmission) be received by some or all of the UEs 115 for which the transmission is intended. For example, it may be desirable that a DCI1 transmitted over a PDCCH associated with a search space set and CORESET be decoded by some or all of the UEs 115 for which the transmission is intended.

In some examples, the piggyback DCI (e.g., a DCI2 or other DCI transmitted over a shared channel, such as a PDSCH) may be an aggregation of multiple grants (e.g., DL or UL grants). As such, the delivery of these grants in PDSCH is more efficient than sending them in the PDCCH region, which would involve additional BD at the UE 115-a.

In some cases, there may be many DCIs to transmit for the same the UE 115-a and there may not be enough space for the PDSCH data anymore (e.g., in the case of a DCI piggybacked over a PDSCH without a downlink shared channel (DL-SCH)). Further, in the case that a PDSCH payload size does not consider DCI piggyback operations, the impact to PDSCH decoding might be high. Thus, in some examples, some PDSCH transmissions may be DCI-only PDSCH transmissions, which may be a special case of DCI piggybacked over a PDSCH, the use of which may be indicated in various ways.

In some examples, a network entity 105-a may address multiple UEs 115 using a DCI1 transmitted over a PDCCH and include all the corresponding the UE 115-a-specific control information for each the UE 115-a in DCI2 carried over a PDSCH without transferring any DL-SCH (i.e., in a broadcast/groupcast PDSCH mode). For example, a network entity 105-a may be tasked with transmitting multiple DL/UL grants to multiple UEs 115 where each the UE 115-a is configured with a DL or an UL grant. In such a case, the network entity 105-a may transmit a DCI1 over a PDCCH to first address the UEs 115 and then use a PDSCH DCI2 transmission to transfer each the UE's 115 specific DCI. Again, in such a situation, it may be desirable that some or all of the UEs 115 receive the PDSCH DCI2 transmission, as it is a shared transmission that includes information for multiple UEs 115. In some examples involving a broadcast/multicast (B/M) DCI-only PDSCH, the payload of the DCI components may be encoded into a single codeword or multiple codewords. For example, in the B/M DCI-only PDSCH case, the PDSCH may include multiple DCI components for different UEs 115 or groups of UEs 115. In some examples, the use of a single codeword may result in a better coding gain due to the larger block length. Such characteristics may be further enhanced if low density parity check (LDPC) encoding/decoding is used. However, this may result into some delay in the case that the B/M DCI-only PDSCH carries multiple DCI components for different UEs 115, and each the UE 115-a may spend some time decoding the entire codeword to find the DCI component that corresponds to the UE 115-a.

In some cases, it may be more beneficial to encode the aggregated payload of the DCI components within the B/M DCI-only PDSCH into multiple codewords. For example, in a first case, each DCI component may be encoded via polar codes. In a further example, in a second case, the aggregated DCI payload size may meet or exceed a threshold amount of bits used in association with a polar encoder (e.g., in some piggyback scenarios, multiple polar codewords may be adopted for such a case). In yet a further example, in a third case in which LDPC is used to encode the DCI components for transmission over a PDSCH, the aggregated DCI payload may be too large to fit into one LDPC codeword.

However, some approaches associated with the case in which the aggregated payload of the DCI components in the B/M DCI-only PDSCH is encoded into multiple codewords may not describe or indicate how to rate-match the coded bits into the available resources such that the DCI components are delivered reliably and the distribution of the resources amongst codewords are fair. Examples and techniques described herein provide such procedures, rules, operations, or information.

For example, to address such situations, a communications system may employ a block interleaver to mix the coded bits from all codewords to achieve maximum diversity for each codeword. Further, in such situations, the DCI components of different UEs 115 may be mapped to one MCS (e.g., the entire B/M DCI-only PDSCH is carried with one modulation order and one code rate) or may be mapped to different MCSs (e.g., mapped to different modulation orders, code rates, or both). For example, in the case of multiple MCSs, different UEs 115 (e.g., the UE 115-a, the UE 115-a 115-b, or other UEs 115) may be grouped together and may have their corresponding DCI components encoded with different MCS levels. However, in either scenario, the B/M DCI-only PDSCH may still be encoded into multiple codewords and a rate-matching rule may be desirable.

Thus, the network entity 105-a may output the first DCI 220 (e.g., a DCI1) via the control channel 235 (e.g., a PDCCH) that is broadcast to a plurality of UEs (e.g., the UE 115-a, the UE 115-b, one or more additional UEs, or any combination thereof). The network entity 105-a may further output, in accordance with the first DCI 220, the second DCI 225 via the shared channel 240 (e.g., a PDSCH) that is broadcast to the plurality of UEs. The second DCI 225 may include UE-specific control information (e.g., the DCI for UE #1, the DCI for UE #2, the DCI for UE #3, the DCI for UE #4, the DCI for UE #5, and the DCI for UE #6) for each UE 115 of the plurality of UEs. In some examples, the UE-specific control information included in the second DCI 225 may include a plurality of codewords that are block interleaved in accordance with a rate matching rule. In accordance with the block interleaving, the rate matching rule, or both, the codewords may be mapped to one or more REs for transmission of the codewords to the UEs 115. The network entity 105-a may further communicate with at least one of the plurality of UEs 115 in accordance with the second DCI 225 (e.g., by transmitting the data communications 230, receiving the data communications 230, or both). In at least this way, the wireless communications system 200 may operate with reduced complexity and processing burden at the UE while preserving and increasing communications quality and reliability.

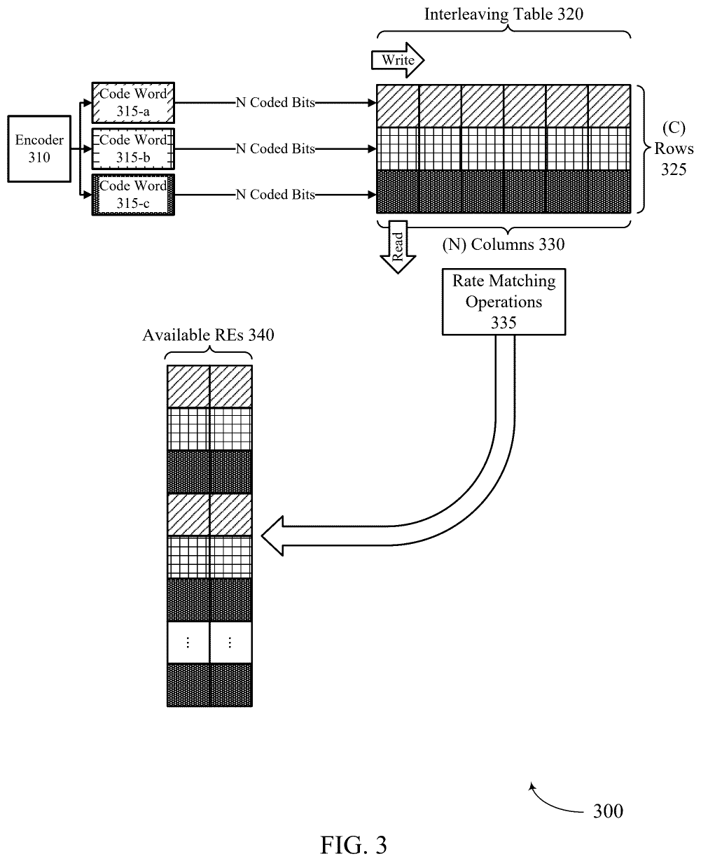

FIG. 3 shows an example of a DCI scheme 300 that supports codeword rate-matching for shared channel DCI transmissions in accordance with one or more examples as disclosed herein. In some cases, aspects of the DCI scheme 300 may implement or be implemented by aspects of FIGS. 1 and 2. For example, the DCI scheme 300 be utilized for encoding multiple codewords that are associated with different UEs 115 that each have information transmitted via a broadcast/multicast DCI-only PDSCH.

In the DCI scheme 300, the encoder 310 may produce one or more codewords 315, such as the codeword 315-a, the codeword 315-b, and the codeword 315-c. Each codeword 315 may include a quantity of coded bits, designated here as N coded bits. Further, an interleaving table 320 may be used to perform block interleaving on the N coded bits. The interleaving table 320 may include a quantity C of rows 325 and a quantity N of columns 330. In some examples, the N coded bits or the M REs may be written to the interleaving table 320 in a first direction (e.g., in the rows 325 of the interleaving table 320) and read from the interleaving table 320 in a second direction (e.g., in the columns 330 of the interleaving table 320). In some examples, the rate matching operations 335 may be performed across one or more elements of the interleaving table 320 and the elements of the interleaving table 320 may be mapped to one or more REs, such as the available REs 340.

For example, in the case that the DCI components are all encoded to have the same quantity of coded bits (N), uniform rectangular block-interleaved rate-matching may be employed. The interleaving table may include N columns 330 and C rows 325, the quantity of rows 325 corresponding to the quantity of codewords 315. To perform the block interleaving, the coded bits of the codewords 315 may be serially concatenated, written in the rows 325 of the interleaving table 320 and read from the columns 330 of the interleaving table 320. In some respects, such techniques may be considered to be a “round-robin” selection across different codewords for coded bits for the interleaving table 320. Thus, the “mixing” of the information of the different codewords may be performed at the bit level (e.g., at the level of the N coded bits of each codeword 315) and the coded bits may be mapped to the available REs 340.

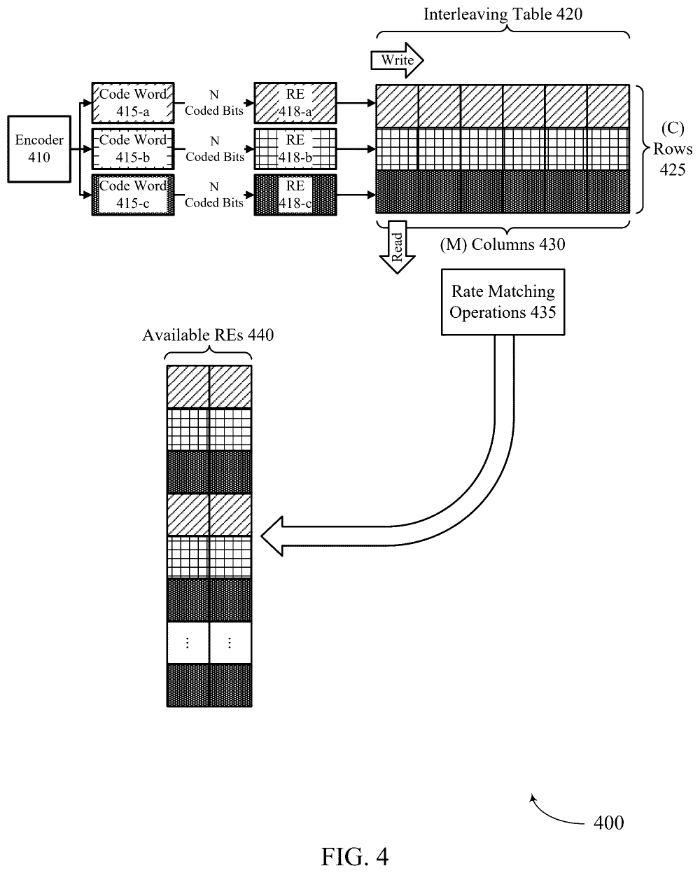

FIG. 4 shows an example of a DCI scheme 400 that supports codeword rate-matching for shared channel DCI transmissions in accordance with one or more examples as disclosed herein. In some cases, aspects of the DCI scheme 400 may implement or be implemented by aspects of FIGS. 1 and 2. For example, the DCI scheme 400 be utilized for encoding multiple codewords that are associated with different UEs 115 that each have information transmitted via a broadcast/multicast DCI-only PDSCH.

In some examples, an RE level mixing may also be performed, in which the coded bits are first mapped to REs and then interleaved in the RE domain. In such a case, each RE may represent k coded bits (or, alternatively, 2^{k} bits for quadrature amplitude modulation (QAM) techniques). For example, in the DCI scheme 400, the encoder 410 may produce one or more codewords 415, such as the codeword 415-a, the codeword 415-b, and the codeword 415-c. Each codeword 415 may include a quantity of coded bits, designated here as N coded bits. In some examples, the coded bits may be mapped to the REs 418. For example, the N coded bits associated with codeword 415-a may be mapped to the RE 418-a, the N coded bits associated with codeword 415-b may be mapped to the RE 418-b, and the N coded bits associated with codeword 415-c may be mapped to the RE 418-c. Further, an interleaving table 420 may be used to perform block interleaving on the REs 418. The interleaving table 420 may include a quantity C of rows 425 and a quantity M of columns 430. In some examples, the REs 418 may be written to the interleaving table 420 in a first direction (e.g., in the rows 425 of the interleaving table 420) and read from the interleaving table 420 in a second direction (e.g., in the columns 430 of the interleaving table 420). In some examples, the rate matching operations 435 may be performed across one or more elements of the interleaving table 420 and the elements of the interleaving table 420 may be mapped to REs, such as the available REs 440.

Here, the quantity M (e.g., the quantity of columns 430) may be expressed as M=N/k, where N is the quantity of coded bits associated with each codeword 415 and k is the quantity of bits associated with each RE. The REs 418 may be serially concatenated, being written in the rows 425 and read from the columns 430. In some respects, such techniques may be considered to be a “round-robin” selection across different codewords of the interleaving table 320 in the RE domain or at the RE level.

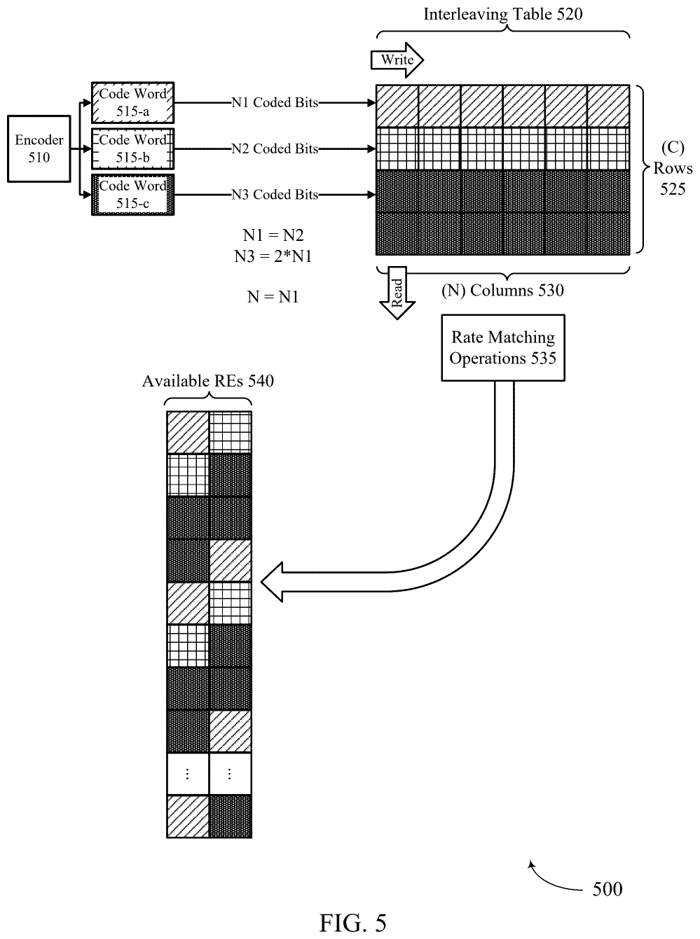

FIG. 5 shows an example of a DCI scheme 500 that supports codeword rate-matching for shared channel DCI transmissions in accordance with one or more examples as disclosed herein. In some cases, aspects of the DCI scheme 500 may implement or be implemented by aspects of FIGS. 1 and 2. For example, the DCI scheme 500 be utilized for encoding multiple codewords that are associated with different UEs 115 that each have information transmitted via a broadcast/multicast DCI-only PDSCH.

In the DCI scheme 500, the encoder 510 may produce one or more codewords 515, such as the codeword 515-a, the codeword 515-b, and the codeword 515-c. Each codeword 515 may include a quantity of coded bits, designated here as N1 coded bits, N2 coded bits, and N3 coded bits for each of the codeword 515-a, the codeword 515-b, and the codeword 515-c, respectively. Further, an interleaving table 520 may be used to perform block interleaving on the coded bits. The interleaving table 520 may include a quantity C of rows 525 and a quantity N of columns 530. In some examples, the N coded bits may be written to the interleaving table 520 in a first direction (e.g., in the rows 525 of the interleaving table 520) and read from the interleaving table 520 in a second direction (e.g., in the columns 530 of the interleaving table 520). In some examples, the rate matching operations 535 may be performed across one or more elements of the interleaving table 520 and the elements of the interleaving table 520 may be mapped to one or more REs, such as the available REs 540.

For example, for the general case that different codewords may have different quantity of coded bits, a block interleaver may still be used (e.g., the interleaving table 520) for interleaving the codewords 515. The quantity N may be the smallest of the lengths of the codewords 515. For example, as depicted, N=N1=6. Further, the quantity C that expressed the quantity of rows 525 in the interleaving table 520 may be expressed as

$$C = ⌈ \frac{N 1 + N 2 + ... + N k}{N} ⌉ .$$

Similar to other cases, the coded bits may be written to the interleaving table 520 in the rows 525 and may be read from the interleaving table 520 in the columns 530.

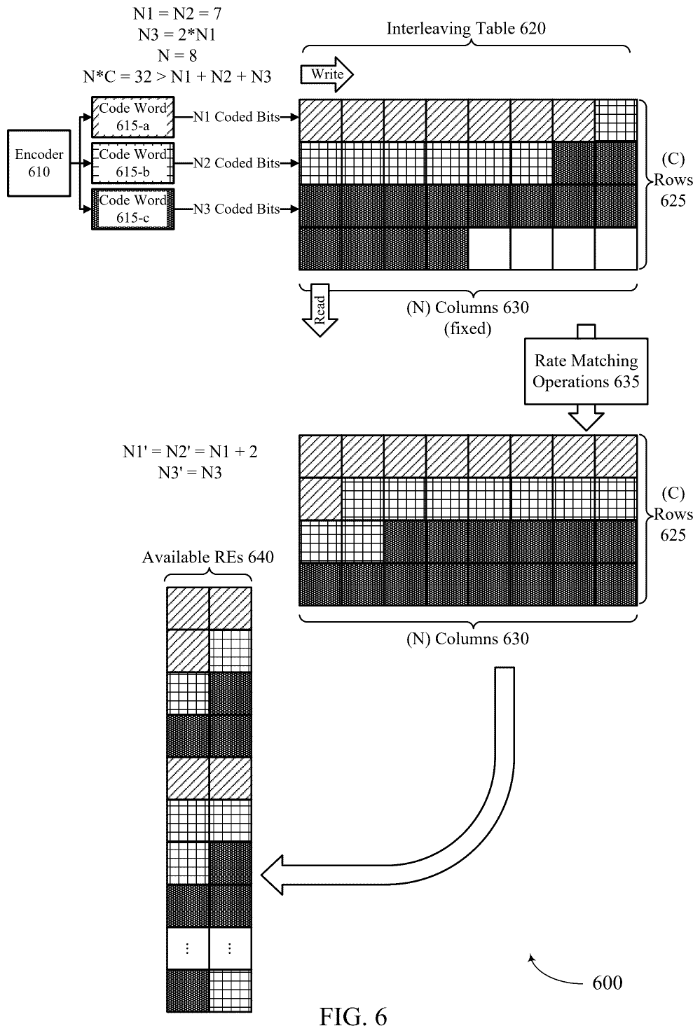

FIG. 6 shows an example of a DCI scheme 600 that supports codeword rate-matching for shared channel DCI transmissions in accordance with one or more examples as disclosed herein. In some cases, aspects of the DCI scheme 600 may implement or be implemented by aspects of FIGS. 1 and 2. For example, the DCI scheme 600 be utilized for encoding multiple codewords that are associated with different UEs 115 that each have information transmitted via a broadcast/multicast DCI-only PDSCH.

In the DCI scheme 600, the encoder 610 may produce one or more codewords 615, such as the codeword 615-a, the codeword 615-b, and the codeword 615-c. Each codeword 615 may include a quantity of coded bits, designated here as N1 coded bits, N2 coded bits, and N3 coded bits, associated with the codeword 615-a, the codeword 615-b, and the codeword 615-c, respectively. Further, an interleaving table 620 may be used to perform block interleaving on the coded bits. The interleaving table 620 may include a quantity C of rows 625 and a quantity N of columns 630. In some examples, the coded bits may be written to the interleaving table 620 in a first direction (e.g., in the rows 625 of the interleaving table 620) and read from the interleaving table 620 in a second direction (e.g., in the columns 630 of the interleaving table 620). In some examples, the rate matching operations 635 may be performed across one or more elements of the interleaving table 620 and the elements of the interleaving table 620 may be mapped to one or more REs, such as the available REs 640.

In some examples, the quantity N may be fixed or preconfigured, in some cases independently from the codeword lengths. For example, the network entity may set a rule that if the total quantity of coded bits (e.g., sum of the coded bits of all codewords) is less than the size of the interleaving table 620, then a repetition of coded bits may be considered to fill in the remaining empty spots. In such a case, the repetition may be done on the codeword with the relatively highest code rate or any other codewords. Additionally, or alternatively, if the total quantity of coded bits (e.g., sum of the coded bits of all codewords) is greater than the size of the interleaving table 620, then a puncturing mechanism may be used to fit the coded bits into the size of the interleaving table 620. In some examples, the puncturing may be done to the codeword with the relatively lowest code rate or any other codeword.

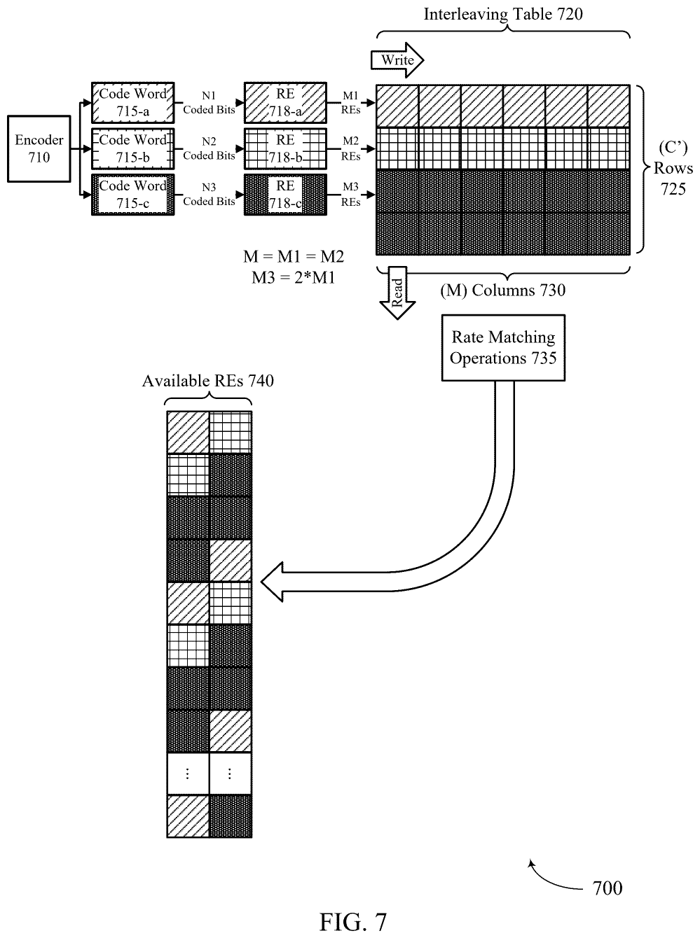

FIG. 7 shows an example of a DCI scheme 700 that supports codeword rate-matching for shared channel DCI transmissions in accordance with one or more examples as disclosed herein. In some cases, aspects of the DCI scheme 700 may implement or be implemented by aspects of FIGS. 1 and 2. For example, the DCI scheme 700 be utilized for encoding multiple codewords that are associated with different UEs 115 that each have information transmitted via a broadcast/multicast DCI-only PDSCH.

In some examples, an RE level mixing may also be performed, in which the coded bits are mapped to REs and interleaved in the RE domain. For example, in the DCI scheme 700, the encoder 710 may produce one or more codewords 715, such as the codeword 715-a, the codeword 715-b, and the codeword 715-c. Each codeword 715 may include a quantity of coded bits, designated here as N1 coded bits, N2 coded bits, and N3 coded bits, associated with the codeword 715-a, the codeword 715-b, and the codeword 715-c, respectively. In some examples, the coded bits of the codewords 715 may be mapped to the REs 718. For example, the N1 coded bits associated with codeword 715-a may be mapped to the RE 718-a, the N2 coded bits associated with codeword 715-b may be mapped to the RE 718-b, and the N3 coded bits associated with codeword 715-c may be mapped to the RE 718-c. Further, an interleaving table 720 may be used to perform block interleaving on the information mapped to the REs 718. The interleaving table 720 may include a quantity C′ of rows 725 and a quantity M of columns 730. In some examples, the information mapped to the REs 718 may be written to the interleaving table 720 in a first direction (e.g., in the rows 725 of the interleaving table 720) and read from the interleaving table 720 in a second direction (e.g., in the columns 730 of the interleaving table 720). In some examples, the rate matching operations 735 may be performed across one or more elements of the interleaving table 720 and the elements of the interleaving table 720 may be mapped to one or more REs, such as the available REs 740.

For the general case in which different codewords have different quantities of coded bits, these codewords may be mapped to different modulation orders. The mapped REs 718 may be serially concatenated, written in the rows 725 and read in the columns 730. The interleaving table 720 of M columns and C′ rows may used for interleaving at the RE level. In some examples, M may be a threshold (e.g., minimum) quantity of REs amongst the quantity of REs of each codeword (e.g., equal to the quantity M1). In some examples, the quantity of rows (e.g., C′) may be expressed as

$${C}^{′} = ⌈ \frac{M 1 + M 2 + ... + M n}{M} ⌉ .$$

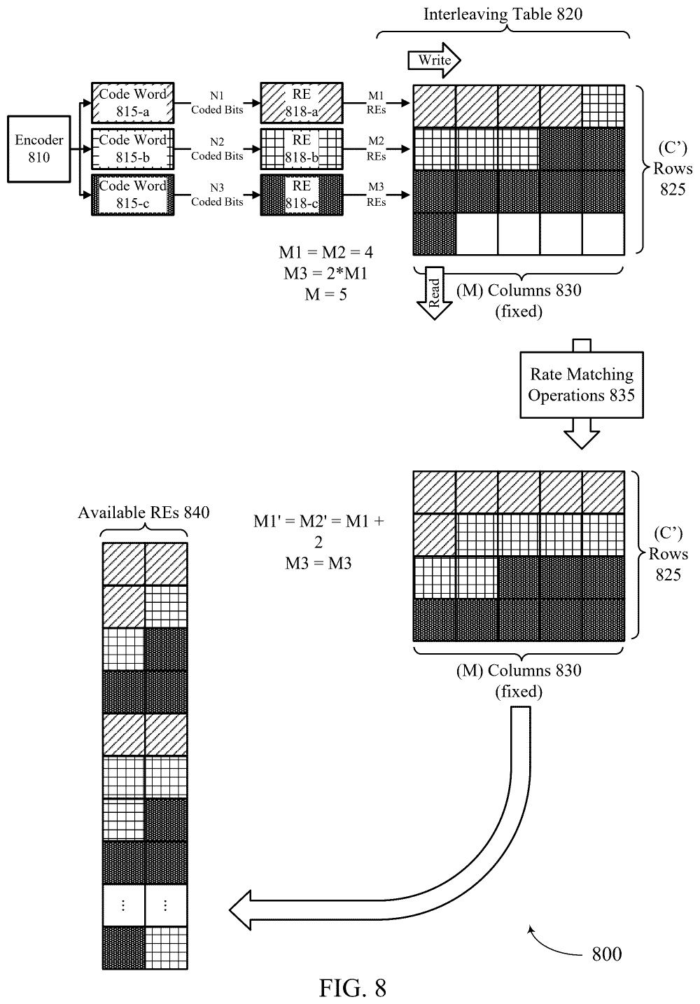

FIG. 8 shows an example of a DCI scheme 800 that supports codeword rate-matching for shared channel DCI transmissions in accordance with one or more examples as disclosed herein. In some cases, aspects of the DCI scheme 800 may implement or be implemented by aspects of FIGS. 1 and 2. For example, the DCI scheme 800 be utilized for encoding multiple codewords that are associated with different UEs 115 that each have information transmitted via a broadcast/multicast DCI-only PDSCH.

In the DCI scheme 800, the encoder 810 may produce one or more codewords 815, such as the codeword 815-a, the codeword 815-b, and the codeword 815-c. Each codeword 815 may include a quantity of coded bits, designated here as N1 coded bits, N2 coded bits, and N3 coded bits, associated with the codeword 815-a, the codeword 815-b, and the codeword 815-c, respectively. In some examples, the coded bits may be mapped to the REs 818. For example, the N1 coded bits associated with codeword 815-a may be mapped to the RE 818-a, the N2 coded bits associated with codeword 815-b may be mapped to the RE 818-b, and the N3 coded bits associated with codeword 815-c may be mapped to the RE 818-c. Further, an interleaving table 820 may be used to perform block interleaving on the REs 818 (e.g., on the information associated with the REs 818 and performed at the RE level). The interleaving table 820 may include a quantity C′ of rows 825 and a quantity M of columns 830 (e.g., which may be fixed). In some examples, the information associated with the REs 818 may be written to the interleaving table 820 in a first direction (e.g., in the rows 825 of the interleaving table 820) and read from the interleaving table 820 in a second direction (e.g., in the columns 830 of the interleaving table 820). In some examples, the rate matching operations 835 may be performed across one or more elements of the interleaving table 820 and the elements of the interleaving table 820 may be mapped to REs, such as the available REs 840.

For example, the quantity M may be fixed or preconfigured, independent of the quantity of REs that are to be interleaved. For example, the network entity may set a rule that if the total quantity of REs (i.e., the sum of the REs associated with the codewords 815) is less than a size of the interleaving table 820, then a repetition of REs 818 may be considered to fill in the remaining empty spots. In such a case, the repetition may be performed on the REs 818 of the codeword with the highest code rate or any other codewords. Additionally, or alternatively, if the total quantity of REs (i.e., the sum of the REs associated with the codewords 815) is greater than a size of the interleaving table 820, then a puncturing mechanism may be used to fit the REs into the dimension of the interleaving table 820. The puncturing may be done to the REs of the codeword with the relatively lowest code rate or any other codeword.

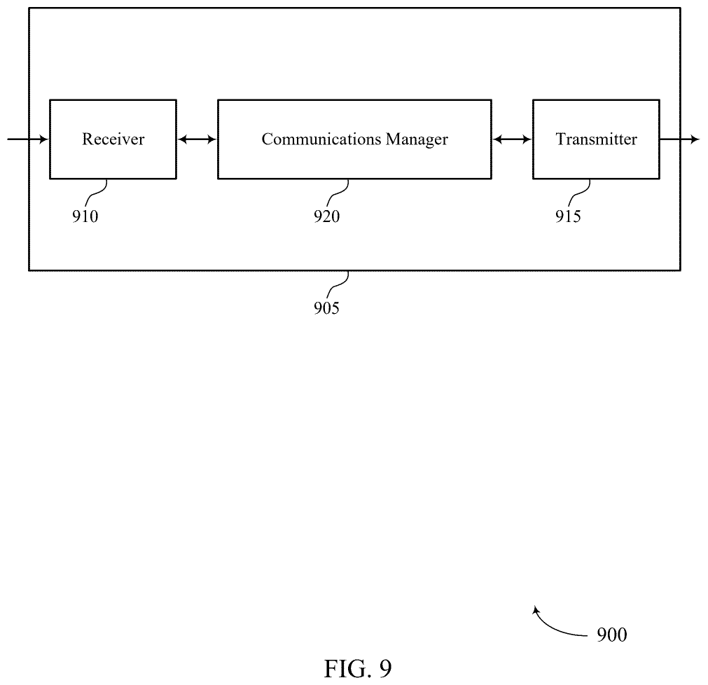

FIG. 9 shows a block diagram 900 of a device 905 that supports codeword rate-matching for shared channel DCI transmissions in accordance with one or more examples as disclosed herein. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of codeword rate-matching for shared channel DCI transmissions as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting a first DCI message via a downlink control channel that is broadcast to a set of multiple UEs. The communications manager 920 is capable of, configured to, or operable to support a means for outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule. The communications manager 920 is capable of, configured to, or operable to support a means for communicating with at least one of the set of multiple UEs in accordance with the second DCI message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, more efficient utilization of communication resources, or any combination thereof.

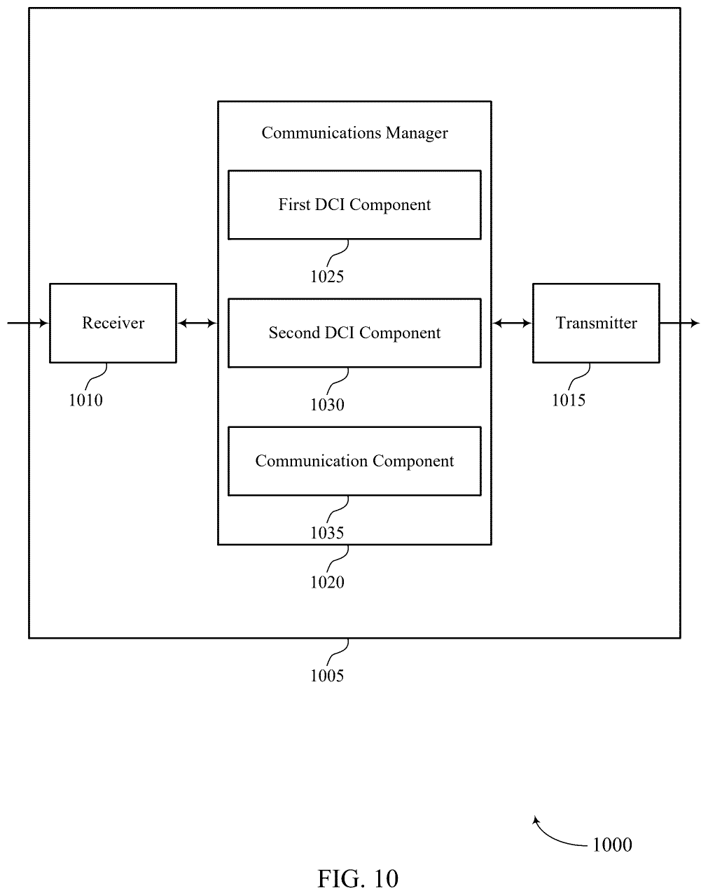

FIG. 10 shows a block diagram 1000 of a device 1005 that supports codeword rate-matching for shared channel DCI transmissions in accordance with one or more examples as disclosed herein. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of codeword rate-matching for shared channel DCI transmissions as described herein. For example, the communications manager 1020 may include a first DCI component 1025, a second DCI component 1030, a communication component 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The first DCI component 1025 is capable of, configured to, or operable to support a means for outputting a first DCI message via a downlink control channel that is broadcast to a set of multiple UEs. The second DCI component 1030 is capable of, configured to, or operable to support a means for outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule. The communication component 1035 is capable of, configured to, or operable to support a means for communicating with at least one of the set of multiple UEs in accordance with the second DCI message.

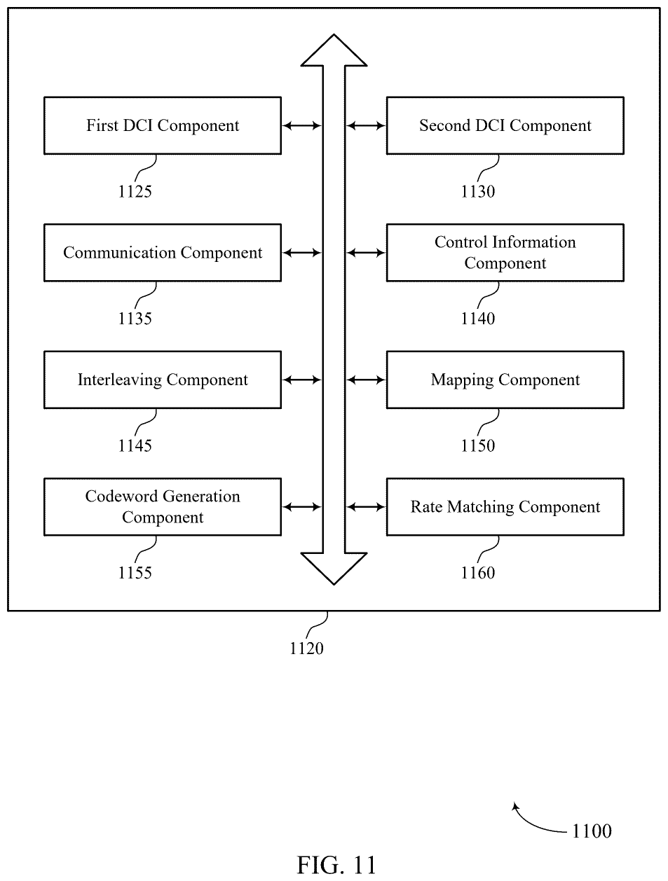

FIG. 11 shows a block diagram 1100 of a communications manager 1120 that supports codeword rate-matching for shared channel DCI transmissions in accordance with one or more examples as disclosed herein. The communications manager 1120 may be an example of aspects of a communications manager 920, a communications manager 1020, or both, as described herein. The communications manager 1120, or various components thereof, may be an example of means for performing various aspects of codeword rate-matching for shared channel DCI transmissions as described herein. For example, the communications manager 1120 may include a first DCI component 1125, a second DCI component 1130, a communication component 1135, a control information component 1140, an interleaving component 1145, a mapping component 1150, a codeword generation component 1155, a rate matching component 1160, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The first DCI component 1125 is capable of, configured to, or operable to support a means for outputting a first DCI message via a downlink control channel that is broadcast to a set of multiple UEs. The second DCI component 1130 is capable of, configured to, or operable to support a means for outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule. The communication component 1135 is capable of, configured to, or operable to support a means for communicating with at least one of the set of multiple UEs in accordance with the second DCI message.

In some examples, the control information component 1140 is capable of, configured to, or operable to support a means for encoding a set of information bits corresponding to the UE-specific control information for each UE to generate the set of multiple codewords. In some examples, the interleaving component 1145 is capable of, configured to, or operable to support a means for writing respective sets of coded bits to at least one row of a set of multiple rows of a block interleaver in accordance with the rate matching rule, each respective set of coded bits corresponding to a codeword of the set of multiple codewords. In some examples, the interleaving component 1145 is capable of, configured to, or operable to support a means for reading, from the block interleaver, the coded bits corresponding to the set of multiple codewords, where the coded bits are sequentially read from a set of multiple columns of the block interleaver. In some examples, the mapping component 1150 is capable of, configured to, or operable to support a means for mapping the coded bits to a set of resources associated with the downlink shared channel based on reading the coded bits from the block interleaver, where the second DCI message is output via the downlink shared channel based on mapping the coded bits to the set of resources.

In some examples, the rate matching rule is associated with uniform block-interleaved rate matching of a same quantity of encoded bits for each codeword, where a quantity of the set of multiple rows is equal to a quantity of the set of multiple codewords, and where a quantity of the set of multiple columns is equal to a quantity of coded bits in each set of coded bits.

In some examples, the rate matching rule is associated with rate matching different quantities of encoded bits for each codeword, and where a quantity of the set of multiple rows is based on a quantity of the set of multiple codewords.

In some examples, a quantity of the set of multiple columns is equal to a smallest quantity of coded bits from the respective sets of coded bits, and where the quantity of the set of multiple rows is based on the respective sets of coded bits and the smallest quantity of coded bits.

In some examples, a quantity of the set of multiple columns includes a preconfigured quantity, and the rate matching component 1160 is capable of, configured to, or operable to support a means for determining that a total quantity of coded bits across the respective sets of coded bits is less than the quantity of the set of multiple columns. In some examples, a quantity of the set of multiple columns includes a preconfigured quantity, and the rate matching component 1160 is capable of, configured to, or operable to support a means for repeating one or more coded bits from at least one of the respective sets of coded bits based on determining that the total quantity of coded bits is less than the quantity of the set of multiple columns.

In some examples, repeating the one or more coded bits is based on a threshold code rate associated with at least one codeword of the set of multiple codewords.

In some examples, a quantity of the set of multiple columns includes a preconfigured quantity, and the rate matching component 1160 is capable of, configured to, or operable to support a means for determining that a total quantity of coded bits across the respective sets of coded bits is greater than the quantity of columns. In some examples, a quantity of the set of multiple columns includes a preconfigured quantity, and the rate matching component 1160 is capable of, configured to, or operable to support a means for puncturing one or more coded bits from at least one of the respective sets of coded bits based on determining that the total quantity of coded bits is greater than the quantity of columns.

In some examples, puncturing the one or more coded bits is based on a threshold code rate associated with at least one codeword of the set of multiple codewords.

In some examples, the codeword generation component 1155 is capable of, configured to, or operable to support a means for encoding a set of information bits corresponding to the UE-specific control information for each UE to generate the set of multiple codewords. In some examples, the mapping component 1150 is capable of, configured to, or operable to support a means for mapping respective sets of coded bits to respective sets of resource elements, each respective set of coded bits corresponding to a codeword of the set of multiple codewords. In some examples, the interleaving component 1145 is capable of, configured to, or operable to support a means for writing the respective sets of resource elements to respective rows of a set of multiple rows of a block interleaver in accordance with the rate matching rule. In some examples, the interleaving component 1145 is capable of, configured to, or operable to support a means for reading, from the block interleaver, the resource elements corresponding to the respective sets of resource elements, where the resource elements are sequentially read from a set of multiple columns of the block interleaver. In some examples, the mapping component 1150 is capable of, configured to, or operable to support a means for mapping the resource elements to a set of resources associated with the downlink shared channel based on reading the resource elements from the block interleaver, where the second DCI message is output via the downlink shared channel based on mapping the resource elements to the set of resources.

In some examples, the rate matching rule is associated with resource element-based block interleaving of a same quantity of encoded bits for each codeword, where a quantity of the set of multiple rows is equal to a quantity of the set of multiple codewords, and where a quantity of the set of multiple columns is equal to a quantity of coded bits in each set of coded bits divided by a quantity of coded bits associated with each resource element.

In some examples, the rate matching rule is associated with rate matching for different quantities of encoded bits for each codeword, where each codeword is associated with a different modulation order, and where a quantity of the respective rows is based on a quantity of the set of multiple columns.

In some examples, the quantity of the set of multiple columns is equal to a smallest quantity of resource elements from the respective sets of resource elements, and where the quantity of the set of multiple rows is based on the respective sets of resource elements and the smallest quantity of coded bits.

In some examples, a quantity of the set of multiple columns includes a preconfigured quantity, and the rate matching component 1160 is capable of, configured to, or operable to support a means for determining that a total quantity of resource elements across the respective sets of resource elements is less than the quantity of the set of multiple columns. In some examples, a quantity of the set of multiple columns includes a preconfigured quantity, and the rate matching component 1160 is capable of, configured to, or operable to support a means for repeating one or more resource elements from at least one of the respective sets of resource elements based on determining that the total quantity of resource elements is less than the quantity of the set of multiple columns.

In some examples, repeating the one or more resource elements is based on a threshold code rate associated with at least one codeword of the set of multiple codewords.

In some examples, a quantity of the set of multiple columns includes a preconfigured quantity, and the rate matching component 1160 is capable of, configured to, or operable to support a means for determining that a total quantity of resource elements across the respective sets of resource elements is greater than the quantity of columns. In some examples, a quantity of the set of multiple columns includes a preconfigured quantity, and the rate matching component 1160 is capable of, configured to, or operable to support a means for puncturing one or more resource elements from at least one of the respective sets of resource elements based on determining that the total quantity of resource elements is greater than the quantity of columns.

In some examples, puncturing the one or more resource elements is based on a threshold code rate associated with at least one codeword of the set of multiple codewords.

In some examples, a quantity of the set of multiple codewords is based on one or more parameters associated with the set of multiple UEs.

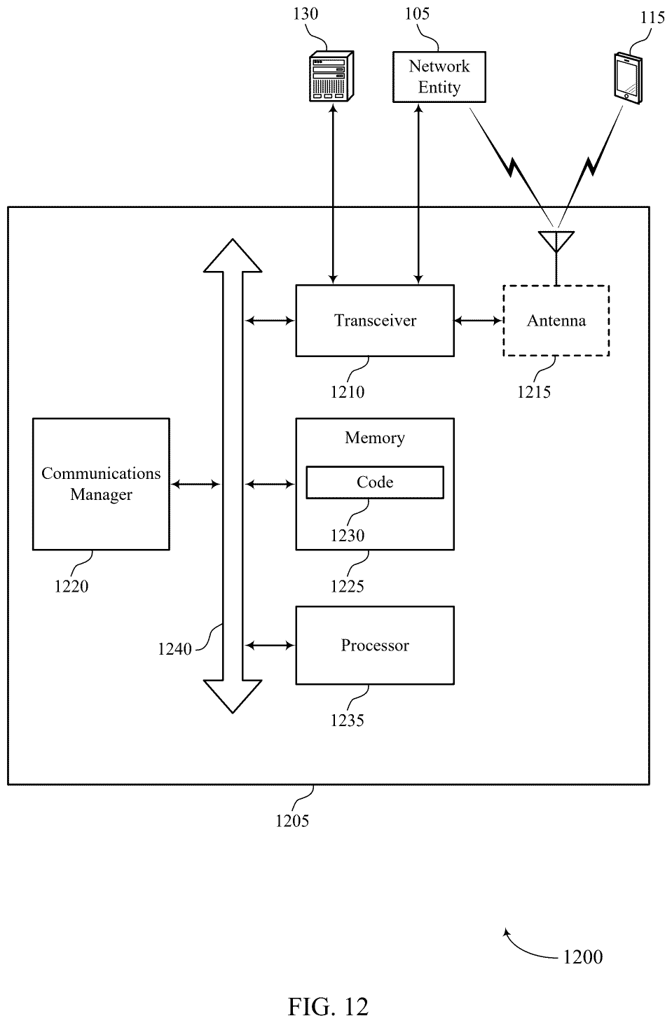

FIG. 12 shows a diagram of a system 1200 including a device 1205 that supports codeword rate-matching for shared channel DCI transmissions in accordance with one or more examples as disclosed herein. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting codeword rate-matching for shared channel DCI transmissions). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting a first DCI message via a downlink control channel that is broadcast to a set of multiple UEs. The communications manager 1220 is capable of, configured to, or operable to support a means for outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule. The communications manager 1220 is capable of, configured to, or operable to support a means for communicating with at least one of the set of multiple UEs in accordance with the second DCI message.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of codeword rate-matching for shared channel DCI transmissions as described herein, or the at least one processor 1235 and the at least one memory 1225 may be otherwise configured to, individually or collectively, perform or support such operations.

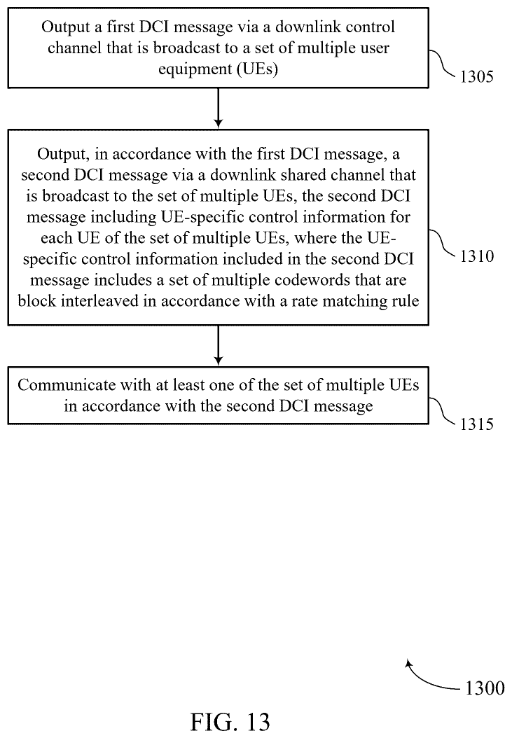

FIG. 13 shows a flowchart illustrating a method 1300 that supports codeword rate-matching for shared channel DCI transmissions in accordance with one or more examples as disclosed herein. The operations of the method 1300 may be implemented by a network entity or its components as described herein. For example, the operations of the method 1300 may be performed by a network entity as described with reference to FIGS. 1 through 12. In some examples, a network entity may execute a set of instructions to control the functional elements of the network entity to perform the described functions. Additionally, or alternatively, the network entity may perform aspects of the described functions using special-purpose hardware.

At 1305, the method may include outputting a first DCI message via a downlink control channel that is broadcast to a set of multiple UEs. The operations of 1305 may be performed in accordance with examples as disclosed herein. In some examples, aspects of the operations of 1305 may be performed by a first DCI component 1125 as described with reference to FIG. 11.

At 1310, the method may include outputting, in accordance with the first DCI message, a second DCI message via a downlink shared channel that is broadcast to the set of multiple UEs, the second DCI message including UE-specific control information for each UE of the set of multiple UEs, where the UE-specific control information included in the second DCI message includes a set of multiple codewords that are block interleaved in accordance with a rate matching rule. The operations of 1310 may be performed in accordance with examples as disclosed herein. In some examples, aspects of the operations of 1310 may be performed by a second DCI component 1130 as described with reference to FIG. 11.

At 1315, the method may include communicating with at least one of the set of multiple UEs in accordance with the second DCI message. The operations of 1315 may be performed in accordance with examples as disclosed herein. In some examples, aspects of the operations of 1315 may be performed by a communication component 1135 as described with reference to FIG. 11.

The following provides an overview of aspects of the present disclosure:
Aspect 1: A method for wireless communications at a network entity, comprising: outputting a first DCI message via a downlink control channel that is broadcast to a plurality of UEs; outputting, in accordance with the first DCI message, a second DCI message via a downlink shared channel that is broadcast to the plurality of UEs, the second DCI message comprising UE-specific control information for each UE of the plurality of UEs, wherein the UE-specific control information included in the second DCI message comprises a plurality of codewords that are block interleaved in accordance with a rate matching rule; and communicating with at least one of the plurality of UEs in accordance with the second DCI message.
Aspect 2: The method of aspect 1, further comprising: encoding a set of information bits corresponding to the UE-specific control information for each UE to generate the plurality of codewords; writing respective sets of coded bits to at least one row of a plurality of rows of a block interleaver in accordance with the rate matching rule, each respective set of coded bits corresponding to a codeword of the plurality of codewords; reading, from the block interleaver, the coded bits corresponding to the plurality of codewords, wherein the coded bits are sequentially read from a plurality of columns of the block interleaver; and mapping the coded bits to a set of resources associated with the downlink shared channel based at least in part on reading the coded bits from the block interleaver, wherein the second DCI message is output via the downlink shared channel based at least in part on mapping the coded bits to the set of resources.
Aspect 3: The method of aspect 2, wherein the rate matching rule is associated with uniform block-interleaved rate matching of a same quantity of encoded bits for each codeword, wherein a quantity of the plurality of rows is equal to a quantity of the plurality of codewords, and wherein a quantity of the plurality of columns is equal to a quantity of coded bits in each set of coded bits.
Aspect 4: The method of any of aspects 2 through 3, wherein the rate matching rule is associated with rate matching different quantities of encoded bits for each codeword, and wherein a quantity of the plurality of rows is based at least in part on a quantity of the plurality of codewords.
Aspect 5: The method of aspect 4, wherein a quantity of the plurality of columns is equal to a smallest quantity of coded bits from the respective sets of coded bits, and wherein the quantity of the plurality of rows is based at least in part on the respective sets of coded bits and the smallest quantity of coded bits.
Aspect 6: The method of any of aspects 4 through 5, wherein a quantity of the plurality of columns comprises a preconfigured quantity, the method further comprising: determining that a total quantity of coded bits across the respective sets of coded bits is less than the quantity of the plurality of columns; and repeating one or more coded bits from at least one of the respective sets of coded bits based at least in part on determining that the total quantity of coded bits is less than the quantity of the plurality of columns.
Aspect 7: The method of aspect 6, wherein repeating the one or more coded bits is based at least in part on a threshold code rate associated with at least one codeword of the plurality of codewords.
Aspect 8: The method of any of aspects 4 through 7, wherein a quantity of the plurality of columns comprises a preconfigured quantity, the method further comprising: determining that a total quantity of coded bits across the respective sets of coded bits is greater than the quantity of columns; and puncturing one or more coded bits from at least one of the respective sets of coded bits based at least in part on determining that the total quantity of coded bits is greater than the quantity of columns.
Aspect 9: The method of aspect 8, wherein puncturing the one or more coded bits is based at least in part on a threshold code rate associated with at least one codeword of the plurality of codewords.
Aspect 10: The method of any of aspects 1 through 9, further comprising: encoding a set of information bits corresponding to the UE-specific control information for each UE to generate the plurality of codewords; mapping respective sets of coded bits to respective sets of resource elements, each respective set of coded bits corresponding to a codeword of the plurality of codewords; writing the respective sets of resource elements to respective rows of a plurality of rows of a block interleaver in accordance with the rate matching rule; reading, from the block interleaver, the resource elements corresponding to the respective sets of resource elements, wherein the resource elements are sequentially read from a plurality of columns of the block interleaver; and mapping the resource elements to a set of resources associated with the downlink shared channel based at least in part on reading the resource elements from the block interleaver, wherein the second DCI message is output via the downlink shared channel based at least in part on mapping the resource elements to the set of resources.
Aspect 11: The method of aspect 10, wherein the rate matching rule is associated with resource element-based block interleaving of a same quantity of encoded bits for each codeword, wherein a quantity of the plurality of rows is equal to a quantity of the plurality of codewords, and wherein a quantity of the plurality of columns is equal to a quantity of coded bits in each set of coded bits divided by a quantity of coded bits associated with each resource element.
Aspect 12: The method of any of aspects 10 through 11, wherein the rate matching rule is associated with rate matching for different quantities of encoded bits for each codeword, wherein each codeword is associated with a different modulation order, and wherein a quantity of the respective rows is based at least in part on a quantity of the plurality of columns.
Aspect 13: The method of aspect 12, wherein the quantity of the plurality of columns is equal to a smallest quantity of resource elements from the respective sets of resource elements, and wherein the quantity of the plurality of rows is based at least in part on the respective sets of resource elements and the smallest quantity of coded bits.
Aspect 14: The method of any of aspects 12 through 13, wherein a quantity of the plurality of columns comprises a preconfigured quantity, the method further comprising: determining that a total quantity of resource elements across the respective sets of resource elements is less than the quantity of the plurality of columns; and repeating one or more resource elements from at least one of the respective sets of resource elements based at least in part on determining that the total quantity of resource elements is less than the quantity of the plurality of columns.
Aspect 15: The method of aspect 14, wherein repeating the one or more resource elements is based at least in part on a threshold code rate associated with at least one codeword of the plurality of codewords.
Aspect 16: The method of any of aspects 12 through 15, wherein a quantity of the plurality of columns comprises a preconfigured quantity, the method further comprising: determining that a total quantity of resource elements across the respective sets of resource elements is greater than the quantity of columns; and puncturing one or more resource elements from at least one of the respective sets of resource elements based at least in part on determining that the total quantity of resource elements is greater than the quantity of columns.
Aspect 17: The method of aspect 16, wherein puncturing the one or more resource elements is based at least in part on a threshold code rate associated with at least one codeword of the plurality of codewords.
Aspect 18: The method of any of aspects 1 through 17, wherein a quantity of the plurality of codewords is based at least in part on one or more parameters associated with the plurality of UEs.
Aspect 19: A network entity for wireless communications, comprising one or more memories storing processor-executable code, and one or more processors coupled with the one or more memories and individually or collectively operable to execute the code to cause the network entity to perform a method of any of aspects 1 through 18.
Aspect 20: A network entity for wireless communications, comprising at least one means for performing a method of any of aspects 1 through 18.
Aspect 21: A non-transitory computer-readable medium storing code for wireless communications, the code comprising instructions executable by one or more processors to perform a method of any of aspects 1 through 18.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
output a first downlink control information (DCI) message via a downlink control channel that is broadcast to a plurality of user equipment (UEs);
output, in accordance with the first DCI message, a second DCI message via a downlink shared channel that is broadcast to the plurality of UEs, the second DCI message comprising UE-specific control information for each UE of the plurality of UEs, wherein the UE-specific control information included in the second DCI message comprises a plurality of codewords that are block interleaved in accordance with a rate matching rule; and
communicate with at least one of the plurality of UEs in accordance with the second DCI message.

2. The network entity of claim 1, wherein the one or more processors are individually or collectively further operable to execute the code to cause the network entity to:
encode a set of information bits corresponding to the UE-specific control information for each UE to generate the plurality of codewords;
write respective sets of coded bits to at least one row of a plurality of rows of a block interleaver in accordance with the rate matching rule, each respective set of coded bits corresponding to a codeword of the plurality of codewords;
read, from the block interleaver, the coded bits corresponding to the plurality of codewords, wherein the coded bits are sequentially read from a plurality of columns of the block interleaver; and
map the coded bits to a set of resources associated with the downlink shared channel based at least in part on reading the coded bits from the block interleaver, wherein the second DCI message is output via the downlink shared channel based at least in part on mapping the coded bits to the set of resources.

3. The network entity of claim 2, wherein the rate matching rule is associated with uniform block-interleaved rate matching of a same quantity of encoded bits for each codeword, wherein a quantity of the plurality of rows is equal to a quantity of the plurality of codewords, and wherein a quantity of the plurality of columns is equal to a quantity of coded bits in each set of coded bits.

4. The network entity of claim 2, wherein the rate matching rule is associated with rate matching different quantities of encoded bits for each codeword, and wherein a quantity of the plurality of rows is based at least in part on a quantity of the plurality of codewords.

5. The network entity of claim 4, wherein a quantity of the plurality of columns is equal to a smallest quantity of coded bits from the respective sets of coded bits, and wherein the quantity of the plurality of rows is based at least in part on the respective sets of coded bits and the smallest quantity of coded bits.

6. The network entity of claim 4, wherein a quantity of the plurality of columns comprises a preconfigured quantity, and the one or more processors are individually or collectively further operable to execute the code to cause the network entity to:
determine that a total quantity of coded bits across the respective sets of coded bits is less than the quantity of the plurality of columns; and
repeat one or more coded bits from at least one of the respective sets of coded bits based at least in part on determining that the total quantity of coded bits is less than the quantity of the plurality of columns.

7. The network entity of claim 6, wherein repeating the one or more coded bits is based at least in part on a threshold code rate associated with at least one codeword of the plurality of codewords.

8. The network entity of claim 4, wherein a quantity of the plurality of columns comprises a preconfigured quantity, and the one or more processors are individually or collectively further operable to execute the code to cause the network entity to:
determine that a total quantity of coded bits across the respective sets of coded bits is greater than the quantity of columns; and
puncture one or more coded bits from at least one of the respective sets of coded bits based at least in part on determining that the total quantity of coded bits is greater than the quantity of columns.

9. The network entity of claim 8, wherein puncturing the one or more coded bits is based at least in part on a threshold code rate associated with at least one codeword of the plurality of codewords.

10. The network entity of claim 1, wherein the one or more processors are individually or collectively further operable to execute the code to cause the network entity to:
encode a set of information bits corresponding to the UE-specific control information for each UE to generate the plurality of codewords;
mapping respective sets of code bits to respective sets of resource elements, each respective set of coded bits corresponding to a codeword of the plurality of codewords;
write the respective sets of resource elements to respective rows of a plurality of rows of a block interleaver in accordance with the rate matching rule;
read, from the block interleaver, the resource elements corresponding to the respective sets of resource elements, wherein the resource elements are sequentially read from a plurality of columns of the block interleaver; and
map the resource elements to a set of resources associated with the downlink shared channel based at least in part on reading the resource elements from the block interleaver, wherein the second DCI message is output via the downlink shared channel based at least in part on mapping the resource elements to the set of resources.

11. The network entity of claim 10, wherein the rate matching rule is associated with resource element-based block interleaving of a same quantity of encoded bits for each codeword, wherein a quantity of the plurality of rows is equal to a quantity of the plurality of codewords, and wherein a quantity of the plurality of columns is equal to a quantity of coded bits in each set of coded bits divided by a quantity of coded bits associated with each resource element.

12. The network entity of claim 10, wherein the rate matching rule is associated with rate matching for different quantities of encoded bits for each codeword, wherein each codeword is associated with a different modulation order, and wherein a quantity of the respective rows is based at least in part on a quantity of the plurality of columns.

13. The network entity of claim 12, wherein the quantity of the plurality of columns is equal to a smallest quantity of resource elements from the respective sets of resource elements, and wherein the quantity of the plurality of rows is based at least in part on the respective sets of resource elements and the smallest quantity of coded bits.

14. The network entity of claim 12, wherein a quantity of the plurality of columns comprises a preconfigured quantity, and the one or more processors are individually or collectively further operable to execute the code to cause the network entity to:
determine that a total quantity of resource elements across the respective sets of resource elements is less than the quantity of the plurality of columns; and
repeat one or more resource elements from at least one of the respective sets of resource elements based at least in part on determining that the total quantity of resource elements is less than the quantity of the plurality of columns.

15. The network entity of claim 14, wherein repeating the one or more resource elements is based at least in part on a threshold code rate associated with at least one codeword of the plurality of codewords.

16. The network entity of claim 12, wherein a quantity of the plurality of columns comprises a preconfigured quantity, and the one or more processors are individually or collectively further operable to execute the code to cause the network entity to:
determine that a total quantity of resource elements across the respective sets of resource elements is greater than the quantity of columns; and
puncture one or more resource elements from at least one of the respective sets of resource elements based at least in part on determining that the total quantity of resource elements is greater than the quantity of columns.

17. The network entity of claim 16, wherein puncturing the one or more resource elements is based at least in part on a threshold code rate associated with at least one codeword of the plurality of codewords.

18. The network entity of claim 1, wherein a quantity of the plurality of codewords is based at least in part on one or more parameters associated with the plurality of UEs.

19. A method for wireless communications at a network entity, comprising:
outputting a first downlink control information (DCI) message via a downlink control channel that is broadcast to a plurality of user equipment (UEs);
outputting, in accordance with the first DCI message, a second DCI message via a downlink shared channel that is broadcast to the plurality of UEs, the second DCI message comprising UE-specific control information for each UE of the plurality of UEs, wherein the UE-specific control information included in the second DCI message comprises a plurality of codewords that are block interleaved in accordance with a rate matching rule; and
communicating with at least one of the plurality of UEs in accordance with the second DCI message.

20. A non-transitory computer-readable medium storing code for wireless communications, the code comprising instructions executable by one or more processors to:
output a first downlink control information (DCI) message via a downlink control channel that is broadcast to a plurality of user equipment (UEs);
output, in accordance with the first DCI message, a second DCI message via a downlink shared channel that is broadcast to the plurality of UEs, the second DCI message comprising UE-specific control information for each UE of the plurality of UEs, wherein the UE-specific control information included in the second DCI message comprises a plurality of codewords that are block interleaved in accordance with a rate matching rule; and
communicate with at least one of the plurality of UEs in accordance with the second DCI message.
